(19) United States
(12) Patent Application Publication
(10) Pub. No.: US 2019/0279320 A1
(43) Pub. Date: Sep. 12, 2019

(54) PATENT CLAIMS ANALYZING METHOD AND APPARATUS

(71) Applicant: WERTINTELLIGENCE, Seoul (KR)

(72) Inventors: Jungho YUN, Seoul (KR); Young-jin JANG, Seoul (KR)

(73) Assignee: WERTINTELLIGENCE, Seoul (KR)

(21) Appl. No.: 16/422,206

(22) Filed: May 24, 2019

Related U.S. Application Data
(63) Continuation of application No. PCT/KR2016/013734, filed on Nov. 25, 2016.

(51) Int. Cl. G06Q 50/18; G06Q 10/10; G06F 17/27

(52) U.S. Cl. CPC G06Q 50/18; G06F 17/27; G06Q 10/10

(57) ABSTRACT

The present disclosure relates to a patent claims analyzing method and apparatus that according to an embodiment may include (a) differentiating claims disclosed in a patent document into independent claims and dependent claims; (b) differentiating the independent claims and the dependent claims into referring claims and referred claims of the referring claims, and analyzing dependency relationships; (c) determining coordinates of the independent claims and the dependent claims according to claim numbers and the dependency relationships; and (d) sequencing the claims according to the coordinates of the independent claims and the dependent claims determined at step (c). The patent claims analyzing method according to the present disclosure may hierarchically structure the claims, thereby enabling easy understanding of the claims.

### CROSS-REFERENCE TO RELATED APPLICATIONS

The present application is a continuation of International Patent Application No. PCT/KR2016/013734, filed Nov. 25, 2016. The disclosure of the above application is hereby incorporated by reference herein in their entirety.

### 1. FIELD

The present disclosure relates to a patent claims analyzing method and apparatus, and more particularly, to a method for analyzing presence of an independent claim in the patent claims and dependency relationships thereof to hierarchically sequence the claims.

### 2. BACKGROUND

Recently, as the importance of intellectual property rights as a means for technology protection grows, interests in patent applications have are also increasing rapidly. Thus, patents are not only playing the role of protecting technology but patent documents are also becoming useful in analyzing recent technology trends or establishing corporate research development strategies.

A patent document consists of bibliographic data, summary, detailed description of the invention and claims, of which the claims contains the technological contents intended for claiming exclusive rights.

Therefore, when reviewing a patent document, it is important to analyze the claims properly in order to understand the patent document.

However, the claims consist of complicated dependency relationships including independent claims or dependent claims, and thus it is not easy to clearly understand the scope of protection of an invention. Moreover, since different countries have different languages and different methods for writing patent claims, it is even more difficult to analyze the entire claims.

There is a prior art technology for providing a method for showing claims where independent claims and dependent claims are distinguished from each other, but this method is not only inaccurate in differentiating the independent claims, but it also does not provide a method for effectively structuring the claims in consideration of the dependency relationships so that the claims can be easily understood in a glance.

### SUMMARY

Therefore, a purpose of the present disclosure is to solve the aforementioned problems of prior art, that is, to provide an analyzing method and apparatus for hierarchically sequencing claims according to dependency relationships of the claims.

Specifically, a technological task that the present disclosure intends to solve is to provide a method for analyzing the dependency relationships of the claims and determining coordinates of each claim, to sequence the claims.

Further, another technological task that the present disclosure intends to resolve is to provide a computer program configured to display the claims so that the claims can be analyzed and visualized.

The technological tasks of the present disclosure are not limited to the aforementioned technological tasks, and other technological tasks that are not mentioned above will be clearly understood by a person in related art based on the disclosure herein below.

In order to achieve the aforementioned tasks, a patent claims analyzing method according to an embodiment of the present disclosure may include (a) differentiating claims disclosed in a patent document into independent claims and dependent claims; (b) differentiating the independent claims and the dependent claims into referring claims and referred claims of the referring claims, and analyzing dependency relationships; (c) determining coordinates of the independent claims and the dependent claims according to claim numbers and the dependency relationships; and (d) sequencing the claims according to the coordinates of the independent claims and the dependent claims determined at step (c).

The coordinates determined for the claims disclosed in the patent document may have unique values that do not overlap one another.

The step (c) may include setting the independent claim as reference coordinates; and determining the coordinates of the dependent claim in lines and rows with reference to the reference coordinates.

For the coordinates of the dependent claim (X, Y), X value may be determined first and then Y value may be determined.

For the coordinates of the dependent claim (X, Y), X value may be determined by:

(if, of other referring claims that refer to the referred claim of the dependent claim, there is a referring claim having a smaller claim number than the claim number of the dependent claim)

X=X value of the coordinates of the referring claim that has a smaller claim number than the claim number of the dependent claim and that is closest to the claim number of the dependent claim, of the referring claims that refer to the referred claim of the dependent claim+n

(here, n is an interval between repeated rows)

(if there is no other referring claim that refers to the referred claim of the dependent claim, or there is no referring claim having a smaller claim number than the claim number of the dependent claim of the other referring claims that refer to the referred claim)

X=X value of the referred claim of the dependent claim+n [Equation 1]

(here, n is an interval between repeated rows)

For the coordinates of the dependent claim (X, Y), Y value may be determined by:

Y=Y value of the referred claim of the dependent claim−m [Equation 2]

(here, m is an interval between repeated lines)

If the dependent claim refers to two or more claims, for the coordinates of the dependent claim (X, Y), Y value may be determined by:

Y=Y value of the referred claim having the smallest Y value of two or more referred claims that refer to the dependent claim−1 [Equation 3]

(here, 1 is an interval between repeated lines)

The step (b) further may further include extracting the referred claim of the dependent claim and calculating the number of the referred claims, and according to the number of the referred claims, differentiating the dependent claim into a single dependent claim if the dependent claim has one referred claim, and into a multiple claim if the dependent claim has two or more referred claims.

The coordinates may include three-dimensional coordinates along X axis, Y axis and Z axis.

A patent claims analyzing apparatus according to an embodiment of the present disclosure may include an inputter for receiving input of information of claims of a patent document; a first controller for differentiating the claims into independent claims and dependent claims, and classifying the independent claims and the dependent claims into referring claims and referred claims of the referring claims, thereby analyzing dependency relationships; a second controller for determining coordinates of the independent claims and the dependent claims according to claim numbers and the dependency relationships; and a display for displaying the claims sequenced according to the determined coordinates.

For the coordinates of the dependent claim (X, Y), X value may be determined by:

(if, of other referring claims that refer to the referred claim of the dependent claim, there is a referring claim having a smaller claim number than the claim number of the dependent claim)

X=X value of the coordinates of the referring claim that has a smaller claim number than the claim number of the dependent claim and that is closest to the claim number of the dependent claim, of the referring claims that refer to the referred claim of the dependent claim+n

(here, n is an interval between repeated rows)

(if there is no other referring claim that refers to the referred claim of the dependent claim, or there is no referring claim having a smaller claim number than the claim number of the dependent claim of the other referring claims that refer to the referred claim)

X=X value of the referred claim of the dependent claim+n [Equation 1]

(here, n is an interval between repeated rows)

If the dependent claim refers to one claim, for the coordinates of the dependent claim (X, Y), Y value may be determined by:

Y=Y value of the referred claim of the dependent claim−m [Equation 2]

(here, m is an interval between repeated lines),

If the dependent claim refers to two or more claims, for the coordinates of the dependent claim (X, Y), Y value may be determined by:

Y=Y value of the referred claim having the smallest Y value of two or more referred claims that refer to the dependent claim−1 [Equation 3]

(here, 1 is an interval between repeated lines)

The independent claim and the dependent claim may be differentiated by one or more elements of color and font.

In sequencing the claims having the determined coordinates, the claims having the dependency relationships may be connected by arrows.

The arrow may be directed from the referring claim towards the referred claim of the referring claim.

Upon receiving input of selecting the referring claim, one or more of color and shape of the arrow connected to the referred claim of the referring claim may be changed.

A computer program stored in a record medium according to an embodiment of the present disclosure may, when combined with a computing apparatus, execute differentiating claims disclosed in a patent document into independent claims and dependent claims; differentiating the independent claims and the dependent claims into referring claims and referred claims of the referring claims, and analyzing dependency relationships; determining coordinates of the independent claims and the dependent claims according to claim numbers and the dependency relationships; and displaying the claims sequenced according to the determined coordinates of the independent claims and the dependent claims.

According to an embodiment of the present disclosure, the independent claims and dependent claims included in the claims are differentiated as referring claims and referred claims, and are thus structured hierarchically, thereby providing an effect of enabling a user to easily understand the entire structure of the claims at a glance.

According to an embodiment of the present disclosure, all the claims are sequenced according to unique coordinate values, thereby providing an effect of enabling the user to easily understand the structure of the claims more easily.

According to an embodiment of the present disclosure, positioning of the claims is determined relatively depending on the presence of a dependency relationship, thereby providing an effect of enabling the user to understand the dependency relationships more easily.

According to an embodiment of the present disclosure, the differentiation of independent claims and dependent claims and claims sequencing through analyzing the dependency relationships are visualized, thereby providing an effect of enabling the user to understand the dependency relationships by each independent claim unit no matter how complicated and long the claims are.

Further, according to an embodiment of the present disclosure, claims that have dependency relationships are connected by arrows, and when the user makes an input of selecting a claim, change of arrows can be observed, thereby providing an effect of enabling the user to check the referred claim of each claim more simply.

Further, an embodiment of the present disclosure can be useful in patent infringement analyzing.

Effects of the present disclosure are not limited to the aforementioned effects, and other effects not mentioned above will be clearly understood to a person in the related art based on the claims.

### BRIEF DESCRIPTION OF THE DRAWINGS

FIG. 1 is a flowchart of a patent claims analyzing method according to an embodiment of the present disclosure;

FIG. 2 is an exemplary view for explaining a method for determining X value of a claim according to another embodiment of the present disclosure;

FIG. 3 is an exemplary view for explaining a method for determining Y value of a claim according to another embodiment of the present disclosure;

FIG. 4 is an exemplary view of coordinates of the claims being determined and then sequenced according to another embodiment of the present disclosure;

FIG. 5 is an exemplary view of coordinates of the claims being determined and then sequenced according to another embodiment of the present disclosure;

FIG. 6 is a block diagram of a patent claims analyzing apparatus according to an embodiment of the present disclosure;

FIG. 7 is an exemplary view of the claims displayed and sequenced by the patent claims analyzing apparatus according to another embodiment of the present disclosure; and

FIG. 8 is an exemplary view where, in the claims displayed and sequenced by the patent claims analyzing apparatus, an arrow is changed upon receiving an input of selecting a referred claim, according to another embodiment of the present disclosure.

### DETAILED DESCRIPTION

Herein below, desirable embodiments of the present disclosure will be explained in detail with reference to the drawings attached. Advantages and characteristics of the present disclosure, and the method for achieving the same will become clear with reference to the embodiments explained herein below in detail together with the drawings attached. However, the present disclosure is not limited to the embodiments disclosed herein below, but may be embodied in various different forms, and the present embodiments are provided merely to complete the present disclosure and to let a person skilled in the art know the scope of the present disclosure, and the present disclosure is to be defined by the claims only. Throughout the entirety of the specification, like reference numerals indicate like configurative elements.

Unless defined otherwise, all terms being used in the present specification (including technological and scientific terms) may be used to have a common meaning to a person skilled in the art. Further, the terms defined in generally used dictionaries shall not be construed ideally or overly unless defined clearly and specially. The terms used in the present specification are intended to explain the embodiments, and not to limit the present disclosure. In the present specification, singular forms include plural forms as well unless specially mentioned in the context.

In the present specification, a patent may be used to include documents having claims such as a patent, utility model and the like. Therefore, in the present specification, a patent may be substituted to a utility model.

In the present specification, claims should be understood as the contents disclosed under the claims section in a patent document. The name of the section specifically representing claims may differ between countries and period, and thus may include all the sections corresponding to claims. One or more claims may be disclosed in the claims section. Claims, claims set, or ‘what is claimed is’ may be used alternately.

In the present specification, an independent claim should be understood as a claim disclosed in an independent form without referring to another claim. Further, a dependent claim is a claim that specifies by limiting or adding to an independent claim or another dependent claim.

In the present specification, a referring claim should be understood as a claim that directly refers to another claim, and a claim may refer to one or more claims. Further, a referred claim should be understood as a claim that is directly referred to by another claim, and a referred claim of a referred claim is not included as a referred claim. That is, the claim that is being referred to is the referred claim. Further, a referred claim of a referring claim should be understood as the claim that the referring claim is referring to. A referring claim and a referred claim that the referring claim is referring to should be understood as being in a dependency relationship.

For example, in the claims herein below, the referred claim of referring claim 2 is claim 1, and the referred claim of referring claim 3 is claim 2 (claim 1 is not included as a referred claim of claim 3). Claims 1 and 2, and claims 2 and 3 are in dependency relationships.

Claim 1: independent claim

Claim 2: referring to claim 1

Claim 3: referring to claim 2

In the present specification, coordinates should be understood as a pair of numbers representing a location of a point on a two-dimensional plane or in a three-dimensional space. The location of the point includes a location of a claim.

Herein below, the present disclosure, a patent claims analyzing method and apparatus, will be explained in detail with reference to the drawings.

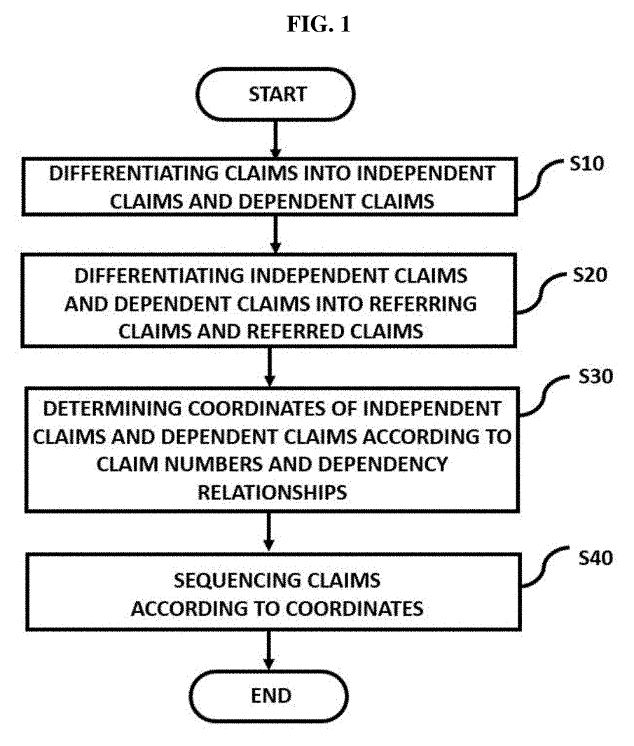

FIG. 1 is a flowchart of a patent claims analyzing method according to an embodiment of the pre sent disclosure.

The patent claims analyzing may include differentiating an independent claim and a dependent claim (S10), differentiating the independent claim and the dependent claim into a referring claim and a referred claim (S20), determining coordinates of the independent claim and the dependent claim according to claim numbers and dependency relationships (S30), and sequencing the claims according to the coordinates (S40).

The claims disclosed in the claims section of a patent document are differentiated into independent claims and dependent claims. Differentiating the claims into independent claims and dependent claims may be conducted by applying an independent claim extraction algorithm that includes determining presence of a claim that it refers to and category of the invention. Determining presence of a claim that it refers to and category of the invention may be conducted by analyzing the text in the front end or rear end of the claim.

By conducting the independent claim extraction algorithm, it is possible to identify presence of a claim that it refers to, and if there is no text about referring to a claim, the claim may be classified as an independent claim, and if there is a text about referring to a claim, the claim may be classified as a dependent claim. However, even if there is a text about referring to a claim, the category of the claim and the category of the claim that is being referred to may be compared against each other, and if their categories are different, the claim may be classified as an independent claim.

The entire claims may be differentiated into independent claims and dependent claims, and then, dependency relationships between the claims may be analyzed.

An independent claim is a claim that is independent and that does not have a claim that it depends on, and may thus be a referred claim.

A dependent claim depends on an independent claim, and may thus be a referring claim. Dependency relationships may be established between dependent claims as well, and thus the dependent claims may also be differentiated into referring claims and referred claims. Here, it is possible to extract the claims (referred claims) that the dependent claim refers to, and calculate the number of the referred claims. Specifically, by analyzing the text disclosed in the front end or rear end of the dependent claim, it is possible to determine how many claims that it refers to. There may be one or more referred claims that the dependent claim refers to, and there is no limitation thereto. When one dependent claim refers to one claim, the dependent claim is called a single dependent claim, and when one dependent claim has two or more referred claims, the dependent claim is called a multiple dependent claim.

By differentiating the independent claims and dependent claims into referring claims and referred claims, it is possible to analyze the dependency relationships of the claims. There may be one or more independent claims in the claims, and it is possible to divide the claims into groups by each independent claim, and analyze the dependency relationships between the dependent claims that refer to each independent claim.

Coordinates may be determined for the claims according to the analyzed dependency relationships and claim numbers. The coordinates may be on a two-dimensional (X axis, Y axis) plane or in a three-dimensional space (X axis, Y axis, Z axis), and the explanation herein below is based on an assumption that the claims are sequenced on a two-dimensional plane.

The coordinates may be determined according to the analyzed dependency relationships and the claim numbers, and may be unique values that do not overlap between claims. This may be applied regardless of the two-dimensional plane or the three-dimensional space.

Coordinates of an independent claim may be set as reference coordinates. When there are two or more independent claims, these independent claims may play the role of reference coordinates for their dependent claims that refer to them. In general, the reference coordinates of an independent claim may be the starting point (0, 0), and when there are two or more independent claims, it is desirable that the reference coordinates of the independent claim having a smaller number become the starting point. However, there is no limitation to location of the reference coordinates of the independent claim.

With reference to the reference coordinates of the independent claim, coordinate values of the dependent claims that refer to the independent claim may be determined by lines and rows. These lines mean the horizontal direction while the rows mean the vertical direction. Further, on the coordinates of the claims, determining the lines may be determining Y values, and determining the rows may be determining X values.

The coordinates of the dependent claim ((X, Y), coordinates are called (X, Y)) may be determined irrespective of the order of lines and rows, but it is desirable to determine the rows first and then determine the lines. Specifically, it is possible to determine the X value of the coordinates and set the location of the row, and then determine the Y value to find the location of the line. Further, there is no definite order for determining the coordinates, but it is desirable to start with determining the X values and Y values of the claims with the smallest claim number.

In the dependent claim coordinates (X, Y), X value may be determined by Equation 1 herein below. Equation 1 herein below may be divided into two number of cases.

(If, of other referring claims that refer to the referred claim of the dependent claim, there is a referring claim having a smaller claim number than that of the dependent claim)

X=X value of the coordinates of the referring claim having a smaller claim number than the claim number of the dependent claim and closest to the claim number of the dependent claim, of the referring claims that refer to the referred claim of the dependent claim+n

(Here, n is an interval between repeated rows)

(If there is no other referring claim of the referred claim of the dependent claim or no other referring claim of the referred claim of the dependent claim having a smaller claim number than the dependent claim)

X=X value of the referred claim of the dependent claim+n [Equation 1]

(Here, n is an interval between the repeated rows)

In the aforementioned Equation 1, n means the interval between the repeated rows, where the interval between the repeated rows may be an arbitrary number exceeding 0, and desirably, the row interval n between all claims being the same may be advantageous in structuring the claims in a regular form.

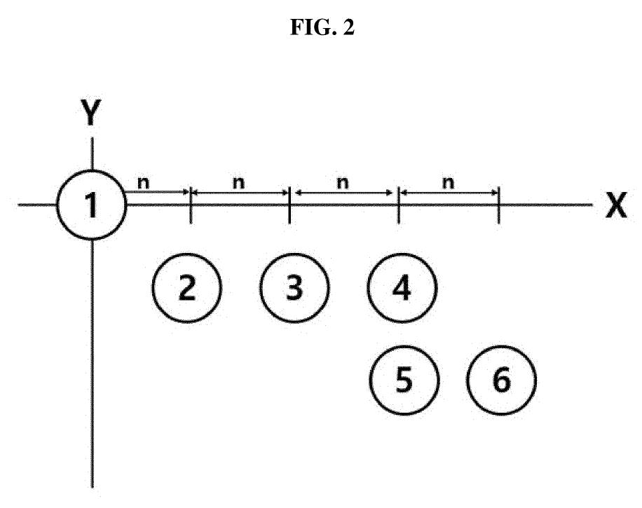

FIG. 2 is an exemplary view for explaining the method for determining the X value of a claim according to another embodiment of the present disclosure. The claims that are subject to FIG. 2 are as in claims 1 below.

[Claims 1]

Claim 1: independent claim

Claim 2: dependent claim/referring to claim 1

Claim 3: dependent claim/referring to claim 1

Claim 4: dependent claim/referring to claim 1

Claim 5: dependent claim/referring to claim 3

Claim 6: dependent claim/referring to claim 4

The X value of claims 1 to 6 were obtained using the aforementioned Equation 1. Claim 1 is an independent claim, whereas claims 2 to 6 are dependent claims since they have claims that they refer to. Claim 1 is an independent claim, and reference coordinates were set to the starting point (0, 0). Claims that also refer to the claim 1 that claim 2 refers to are claims 3 and 4, none of which has a smaller claim number than claim 2, and thus the X value of claim 2 is equivalent to the X value of claim 1 (a referred claim that claim 2 refers to) plus n (interval between the repeated rows). Claims that also refer to claim 1 that claim 3 refers to are claims 2 and 4, of which claim 2 has a smaller claim number than claim 3, and thus the X value of claim 3 is equivalent to the X value of claim 2 (the claim having a smaller claim number than claim 3 and that is closest to claim 3) plus n. To construe claim 4 in the same method as claim 3, the X value of claim 4 is equivalent to the X value of claim 3 plus n. Regarding claim 5, there is no other claim that refers to claim 3, which claim 5 is referring to, and thus the value of claim 5 is equivalent to the X value of claim 3 (referred claim of claim 5) plus n. Likewise, claim 6 is the only claim that refers to claim 4, just as claim 5 was, and thus the X value of claim 6 is equivalent to the X value of claim 4 plus n. Therefore, with reference to claim 1, which is an independent claim, the X value gets bigger in the order of claim 2-claim 3-claims 4 and 5-claim 6.

In the dependent claim coordinates (X, Y), Y value may be determined by Equation 2 and Equation 3 herein below. Equation 2 and equation 3 herein below may differ depending on the number of the referred claims that the referring claims refer to, in other words, whether or not it is a single dependency claim or a multiple dependency claim.

(when the dependent claim refers to one claim)

Y=Y value of the referred claim of the dependent claim−m [Equation 2]

(Here, m is an interval between the repeated lines)

(when the dependent claim refers to two or more claims)

Y=Y value of the referred claim having the smallest Y value of the two or more referred claims that is referred to by the dependent claim−1 [Equation 3]

(Here, 1 is an interval between the repeated lines)

In the aforementioned Equation 2, m means the interval between the repeated lines, and here the interval between the lines may be an arbitrary number that exceeds 0, and desirably, the line interval m between the claims being the same may be advantageous in structuring the claims in a regular form. The same goes with 1 of the aforementioned Equation 2.

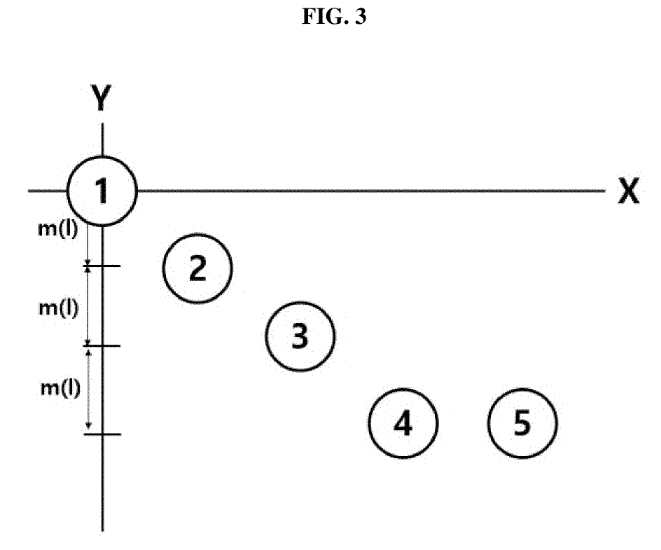

FIG. 3 is an exemplary view for explaining the method for determining the Y value of the claims according to another embodiment of the present disclosure. The claims that are subject to FIG. 3 are as in claims 2 herein below.

[Claims 2]

Claim 1: independent claim

Claim 2: dependent claim/referring to claim 1 (single dependent claim)

Claim 3: dependent claim/referring to claim 2 (single dependent claim)

Claim 4: dependent claim/referring to claims 2 and 3 (multiple dependent claim)

Claim 5: dependent claim/referring to claims 2 and 3 (multiple dependent claim)

The Y values of claims 1 to 5 were obtained using the aforementioned Equations 2 and 3. Claim 1 is an independent claim, whereas claims 2 to 5 are dependent claims since they have claims that they refer to. Claim 1 is an independent claim, and reference coordinates were set to the starting point (0, 0). Regarding claim 2, since it refers to one claim, Equation 2 applies. According to Equation 2, the Y value of claim 2 is equivalent to the Y value of claim 1 (referred claim that claim 2 refers to) minus m. Claim 3 is also a single dependent claim, and thus the Y value of claim 3 is equivalent to the Y value of claim 2 that is referred to by claim 3 minus m. Claim 4 is referred to by claims 2 and 3, and is thus a multiple dependent claim, and thus Equation 3 applies. According to Equation 3, of the referred claims that claim 4 refers to, claim 3 has the smallest Y value (Y value of claim 2=−1, Y value of claim 3=−21), and thus, the Y value of claim 4 is equivalent to the Y value of claim 3 minus 1. Since claim 5 is also a multiple dependent claim, the Y value of claim 3, having a smaller Y value than claim 2, minus 1 becomes equivalent to the Y value of claim 5. Therefore, with reference to claim 1, the Y value becomes smaller in the order of claim 2-claim 3-claims 4 and 5.

By combining the aforementioned Equations 1, 2, and 3, it is possible to determine the X value and the Y value for each claim, and since each claim has a different claim number and different characteristics of dependency relationships, each claim ends up having unique coordinate values. That is, the coordinate values of each claim cannot overlap one another.

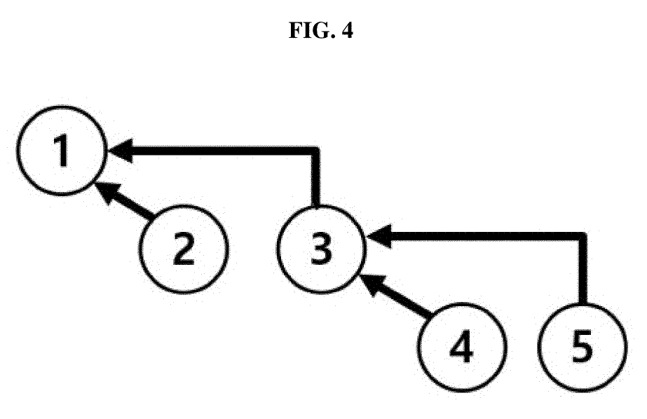

FIG. 4 is an exemplary view of claims sequenced upon determining the coordinates according to another embodiment of the present disclosure. The claims subject to FIG. 4 are as in claims 3 herein below.

[Claims 3]

Claim 1: independent claim

Claim 2: dependent claim/referring to claim 1

Claim 3: dependent claim/referring to claim 1

Claim 4: dependent claim/referring to claim 3

Claim 5: dependent claim/referring to claim 3

Coordinate values of claims 1 to 5 were determined by substituting the aforementioned Equations 1, 2, and 3 into the aforementioned claims 3. For ease of calculation, 1 was applied to n, m, and l of each Equation. First, claim 1 is an independent claim, and reference coordinates were set to the starting point (0, 0). Next, the X value of each claim was determined. Claim 2 refers to claim 1 together with claim 3, but since there is no claim with a claim number that comes before claim 2, the X value of claim 2 is the X value of claim 1 plus 1, and as for claim 3, since there is claim 2 referring to claim 1, the X value of claim 3 is the X value of claim 2 plus 1, that is 2. The X value of claim 4 is the X value of claim 3 plus 1, that is, 3. The X value of claim 5 is the X value of claim 4 plus 1, that is, 4. Then, the Y values of the claims of which the X values have been determined are calculated. Claims 2 to 5 are all single dependent claims, and thus the Y value of each of these claims is the Y value of each referred claim minus 1. Therefore, the determined coordinates are claim 1 (0, 0), claim 2 (1, −1), claim 3 (2, −1), claim 4 (3, −2), and claim 5 (4, −2), and when the claims that have dependency relationships are connected with arrows, claims 1 to 5 will be sequenced as in FIG. 4.

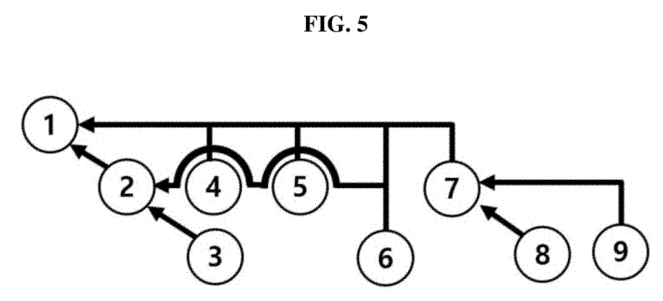

FIG. 5 is an exemplary view of claims sequenced upon determining the coordinates according to another embodiment of the present disclosure. The claims subject to FIG. 5 are as in claims 4 herein below.

[Claims 4]

Claim 1: independent claim

Claim 2: dependent claim/referring to claim 1 (single claim)

Claim 3: dependent claim/referring to claim 2 (single claim)

Claim 4: dependent claim/referring to claim 1 (single claim)

Claim 5: dependent claim/referring to claim 1 (single claim)

Claim 6: dependent claim/referring to claims 1 and 2 (multiple claim)

Claim 7: dependent claim/referring to claim 1 (single claim)

Claim 8: dependent claim/referring to claim 7 (single claim)

Claim 9: dependent claim/referring to claim 7 (single claim)

The coordinate values of claims 1 to 5 were determined by substituting the aforementioned Equations 1, 2, and 3 into the aforementioned claims 4. For ease of calculation, 1 was applied to n, m, and l of each Equation. Claim 6 was calculated as an example. Claim 6 refers to claims 1 and 2, and of the claims that refer to claims 1 and 2, claims 2, 3, 4, and 5 are the claims having smaller claim numbers than claim 6, and thus the X value of claim 6 is equivalent to the X value of claim 5, having the closest claim number with claim 6, plus 1, that is, 4. As for the Y value, of the referred claims of claim 6, the claim having the smallest Y value is claim 2 (Y value=−1), and thus the Y value of claim 6 is equivalent to the Y value of claim 2 minus 1, that is, −2. Therefore, the coordinates of claim 6 is (4, −2).

If the coordinate values of the remaining claims are calculated as aforementioned, the determined coordinates will be claim 1 (0, 0), claim 2 (1, −1), claim 3 (1, −2), claim 4 (2, −1), claim 5 (3, −1), claim 6 (4, −2), claim 7 (5, −1), claim 8 (6, −2), and claim 9 (7, −2). When the determined coordinates claims are sequenced and dependency relationships are displayed using arrows, claims 1 to 9 will be sequenced as in FIG. 5.

According to the patent claims analyzing method according to another embodiment of the present disclosure, determining coordinates may be realized in a three-dimensional space as well. In this case, it is possible to express the extent of dependency (the number of times of dependency in the case of referring claims) using another coordinate value, thereby sequencing the claims three-dimensionally.

The patent analyzing method may be performed by a patent claim analyzing apparatus 100.

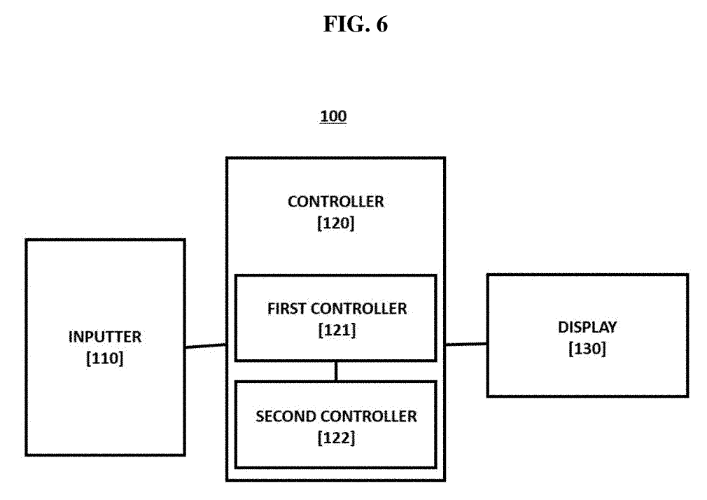

FIG. 6 is a block diagram of the patent claim analyzing apparatus according to an embodiment of the present disclosure. Referring to FIG. 6, the patent claim analyzing apparatus according to the embodiment of the present disclosure 100 may include an inputter 110, a controller 120 and a display 130. The controller 120 may include a first controller 121 and a second controller 122.

The inputter 110 receives input of information of patent claims. Especially, the inputter 110 may receive input of the information regarding the patent claims from a patent document being input by a user in the patent claims analyzing apparatus 100, or extract a text corresponding to the patent claims from the patent document being input by the user and receive input of the information. Further, the patent document being input into the inputter 110 may include at least one form of laid-open patent gazette, registered patent gazette, patent document laid-open number, patent document registration number, title of the invention (title of the devise), and patent document image, but there is no limitation thereto.

The inputter 110 may be configured to include an input means of an arbitrary form that is well-known in the related art. For example, the inputter 110 may be configured to include at least one of keyboard, mouse, button, and touch screen for receiving user input.

The controller 120 controls the overall operations of each configuration of the patent claims analyzing apparatus 100.

The controller 120 may be configured to include a first controller 121 for differentiating independent claims and/or analyzing dependency relationships and a second controller 122 for determining coordinates of the claims.

The first controller 121 may differentiate the claims in a patent document into independent claims and dependent claims so as to classify the independent claims and the dependent claims into referring claims and referred claims of the referring claims, thereby analyzing the dependency relationships, while the second controller 122 may perform the determining of the coordinates of the independent claims and the dependent claims according to the claim numbers and the dependency relationships.

The controller 120 may be configured to include a Central Processing Unit (CPU), a Micro Processor Unit (MPU), a Micro Controller Unit (MCU), or a processor having an arbitrary form that is well-known in the related field. The controller 120 may also be configured to include a memory, for example, a RAM. Further, the controller 120 may store at least one application or program for executing the method according to the embodiment of the present disclosure. For example, the controller 120 may store a patent claims analyzing program according to an embodiment of the present disclosure, and execute the same. As the controller 120 executes the patent claims analyzing program, the patent claims analyzing method according to the embodiment of the present disclosure may be performed.

Specifically, as a patent claims analyzing process according to the embodiment of the present disclosure such as user input, differentiating independent claims, analyzing dependency relationships and/or determining coordinates of claims is performed, the controller 120 may change the display object of the display 130.

According to an embodiment of the present disclosure, the controller 120 may store a plurality of lower modules in order to perform functions of the embodiment of the present disclosure.

The display 130 displays various data, commands, information and/or GUI to the user. The display 130 may sequence the coordinates of the claims determined in the controller 120, and display an entirety or portion of the sequenced coordinates.

The independent claims, dependent claims, single dependent claims, and multiple dependent claims may be differentiated by one or more elements of color and font.

The display 130 may connect the claims having dependency relationships with arrows while sequencing the claims according to the coordinates and display the same. Here, the arrows may be directed from the referring claims towards the referred claims of the referring claims. The direction of the arrows may be diagonal, perpendicular to the X axis or vertical to the Y axis, and in some cases, a combination of two types of directions. Further, if there is another claim along the route where the arrow is to be created from the referring claim towards the referred claim, the arrow may be created to go around the other claim, in which case, a portion or entirety of the line constituting the arrow may be a curved line.

Upon receiving input of selecting a referring claim from the sequenced claims, one or more of the color and shape of the arrow connected to the referred claim of the referring claim may be changed. Further, the change of color and/or shape may be operated to have an animation effect. Upon receiving input of selecting an area besides the area for receiving input of selecting the referring claim, the change of arrows may be cancelled.

Upon receiving input of selecting a referring claim, the claim text of the selected referring claim may be displayed. Desirably, the referring claim and the claim text of the referred claim of the referring claim may be displayed together.

The display 130 of the present disclosure may be configured to further include a display means having an arbitrary form well-known in the related art. For example, the display 130 may be configured as a touch screen equipped with a PC monitor or a touch sensor. When the display 130 is configured as a touch screen, it may function as the inputter 110.

Meanwhile, although not illustrated herein, the patent claims analyzing apparatus 100 may further include a communicator. The communicator may support wired/wireless internet communication or intranet communication of the patent claims analyzing apparatus 100, and transceiver various information to and from an external device. The communicator may be provided with a claims model and a predefined independent claims differentiation or dependency relationship analyzing rules from the external device. Further, the communicator may transmit data related to analyzing the claims to the external device in order to process the claims model and the predefined independent claims differentiation or dependency relationship analyzing rules, and receive processing results from the external device. Specifically, the communicator may transmit to the external apparatus data containing a claims structure according to a predefined protocol and receive its processing results from the external apparatus.

Further, although not illustrated herein, the patent claims analyzing apparatus 100 may include a storage. The storage stores various data, commands and/or information. The storage may store one or more applications necessary for being provided with the patent analyzing method according to the embodiment of the present disclosure. Further, the storage may store various information being received through the communicator and various information being input through the inputter.

The storage may store the data and the like delivered from the external apparatus temporarily or non-temporarily. The storage may be configured to include a Read Only Memory (ROM), Erasable Programmable ROM (EPROM), Electrically Erasable Programmable ROM (EEPROM), nonvolatile memory such as flash memory and the like, hard disc, detachable disc, or a record medium that can be read by a computer of an arbitrary form that is well-known in the related art.

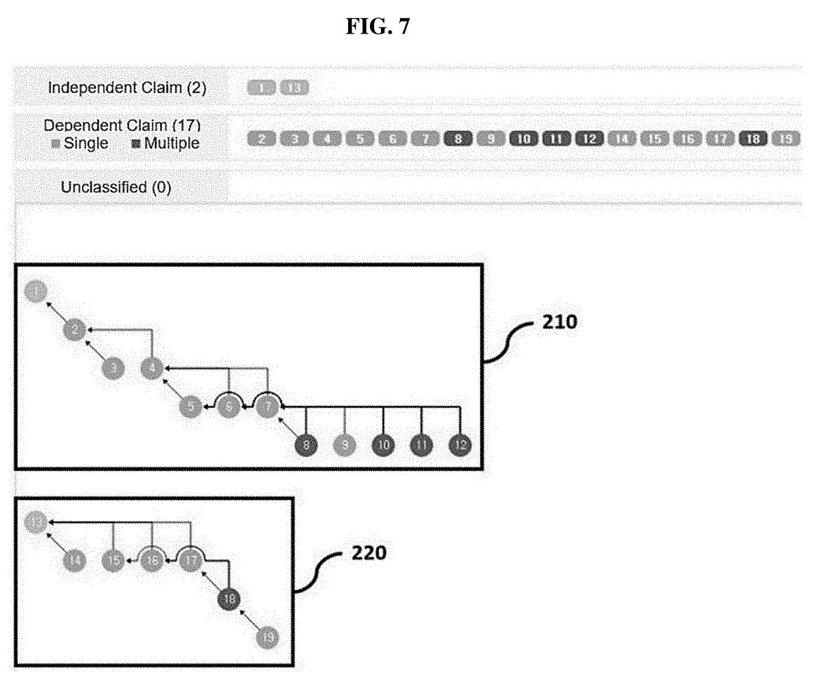

FIG. 7 is an exemplary view of claims displayed and sequenced by a patent claims analyzing apparatus according to another embodiment of the present disclosure.

The patent claims analyzing apparatus 100 may determine each of the independent claims groups 210, 220 as a different independent claims group, and visualize and create the dependency relationships of the dependent claims per independent group. Applying different colors to the claim numbers of the independent claims, single dependent claims and multiple dependent claims is illustrated as an example.

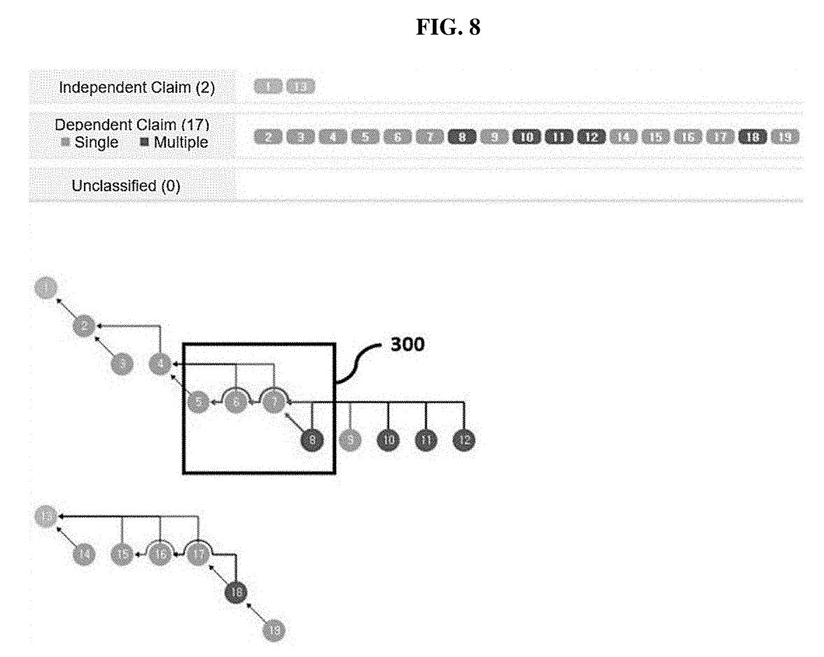

FIG. 8 is an exemplary view where the shape of an arrow has been changed upon receiving input of selecting a referring claim of the patent claims displayed and sequenced by the patent claims analyzing apparatus according to another embodiment of the present disclosure.

Referring to FIG. 8, upon receiving input of selecting claim 8, claims 5 and 7 that refer to claim 8 may be connected, and the color of the arrow may be changed and displayed (300).

The patent claims analyzing apparatus 100 may be operated by a patent claims analyzing program.

The computer program stored in the record medium according to the embodiment of the present disclosure may combine with a computing apparatus, and execute the step of differentiating the claims disclosed in the patent document into independent claims and dependent claims, differentiating the independent claims and the dependent claims into referring claims and referred claims of the referring claims and analyzing dependency relationships, determining coordinates of the independent claims and the dependent claims according to claim numbers and the dependency relationships, and displaying the claims sequenced according to the determined coordinates of the independent claims and the dependent claims.

The methods according to the embodiments of the present disclosure explained so far with reference to the drawings attached may be performed by execution of a computer program embodied in computer-readable codes. The computer program may be transmitted from a first computing apparatus to a second computing apparatus via a network such as the internet and the like, and be installed in the second computing apparatus, and thus used in the second computing apparatus. The first computing apparatus and the second computing apparatus includes server devices, stationary computing devices such as desktop PCs, and mobile computing apparatuses such as notebooks, smartphones, and tablet PCs.

Embodiments of the present disclosure were explained with reference to the drawings attached hereto, but a person skilled in the art will understand that the present disclosure may be implemented in other specific forms without changing its technical idea or essential characteristics. Therefore, the embodiments disclosed hereinabove must be understood as exemplary and not limiting the present disclosure in all aspects.

### INDUSTRIAL FEASIBILITY

The present disclosure relates to a method for analyzing presence of independent claims in the claims and the dependency relationships, thereby hierarchically sequencing the claims, and thus has industrial feasibility.

What is claimed is:

1. A patent claims analyzing method comprising:
(a) differentiating claims disclosed in a patent document into independent claims and dependent claims;
(b) differentiating the independent claims and the dependent claims into referring claims and referred claims of the referring claims, and analyzing dependency relationships;
(c) determining coordinates of the independent claims and the dependent claims according to claim numbers and the dependency relationships; and
(d) sequencing the claims according to the coordinates of the independent claims and the dependent claims determined at step (c).

2. The patent claims analyzing method according to claim 1,
wherein the coordinates determined for the claims disclosed in the patent document have unique values that do not overlap one another.

3. The patent claims analyzing method according to claim 1,
wherein step (c) comprises:
setting the independent claim as reference coordinates; and
determining the coordinates of the dependent claim in lines and rows with reference to the reference coordinates.

4. The patent claims analyzing method according to claim 3,
wherein, for the coordinates of the dependent claim (X, Y), X value is determined first and then Y value is determined.

5. The patent claims analyzing method according to claim 1,
wherein, for the coordinates of the dependent claim (X, Y), X value is determined by:
(if, of other referring claims that refer to the referred claim of the dependent claim, there is a referring claim having a smaller claim number than the claim number of the dependent claim)
X=X value of the coordinates of the referring claim that has a smaller claim number than the claim number of the dependent claim and that is closest to the claim number of the dependent claim, of the referring claims that refer to the referred claim of the dependent claim+n (here, n is an interval between repeated rows)
(if there is no other referring claim that refers to the referred claim of the dependent claim, or there is no referring claim having a smaller claim number than the claim number of the dependent claim of the other referring claims that refer to the referred claim)
X=X value of the referred claim of the dependent claim+n [Equation 1]
(here, n is an interval between repeated rows).

6. The patent claims analyzing method according to claim 1,
wherein, if the dependent claim refers to one claim, for the coordinates of the dependent claim (X, Y), Y value is determined by:
Y=Y value of the referred claim of the dependent claim [Equation 2]
(here, m is an interval between repeated lines).

7. The patent claims analyzing method according to claim 1,
wherein, if the dependent claim refers to two or more claims, for the coordinates of the dependent claim (X, Y), Y value is determined by:
Y=Y value of the referred claim having the smallest Y value of two or more referred claims that refer to the dependent claim−1 [Equation 3]
(here, 1 is an interval between repeated lines).

8. The patent claims analyzing method according to claim 1,
wherein step (b) further comprises:
extracting the referred claim of the dependent claim and calculating the number of the referred claims, and
according to the number of the referred claims, differentiating the dependent claim into a single dependent claim if the dependent claim has one referred claim, and into a multiple claim if the dependent claim has two or more referred claims.

9. The patent claims analyzing method according to claim 1,
wherein the coordinates include three-dimensional coordinates along X axis, Y axis and Z axis.

10. A patent claims analyzing apparatus comprising:
an inputter for receiving input of information of claims of a patent document;
a first controller for differentiating the claims into independent claims and dependent claims, and classifying the independent claims and the dependent claims into referring claims and referred claims of the referring claims, thereby analyzing dependency relationships;
a second controller for determining coordinates of the independent claims and the dependent claims according to claim numbers and the dependency relationships; and
a display for displaying the claims sequenced according to the determined coordinates.

11. The patent claims analyzing apparatus according to claim 10,
wherein, for the coordinates of the dependent claim (X, Y), X value is determined by:
(if, of other referring claims that refer to the referred claim of the dependent claim, there is a referring claim having a smaller claim number than the claim number of the dependent claim)
X=X value of the coordinates of the referring claim that has a smaller claim number than the claim number of the dependent claim and that is closest to the claim number of the dependent claim, of the referring claims that refer to the referred claim of the dependent claim+n
(here, n is an interval between repeated rows)
(if there is no other referring claim that refers to the referred claim of the dependent claim, or there is no referring claim having a smaller claim number than the claim number of the dependent claim of the other referring claims that refer to the referred claim)
X=X value of the referred claim of the dependent claim+n [Equation 1]
(here, n is an interval between repeated rows).

12. The patent claims analyzing apparatus according to claim 10,
wherein, if the dependent claim refers to one claim, for the coordinates of the dependent claim (X, Y), Y value is determined by:
Y=Y value of the referred claim of the dependent claim—m [Equation 2]
(here, m is an interval between repeated lines),
if the dependent claim refers to two or more claims, for the coordinates of the dependent claim (X, Y), Y value is determined by:
Y=Y value of the referred claim having the smallest Y value of two or more referred claims that refer to the dependent claim−1 [Equation 3]
(here, 1 is an interval between repeated lines).

13. The patent claims analyzing apparatus according to claim 10,
wherein the independent claim and the dependent claim are differentiated by one or more elements of color and font.

14. The patent claims analyzing apparatus according to claim 10,
wherein, in sequencing the claims having the determined coordinates, the claims having the dependency relationships are connected by arrows.

15. The patent claims analyzing apparatus according to claim 14,
wherein the arrow is directed from the referring claim towards the referred claim of the referring claim.

16. The patent claims analyzing apparatus according to claim 14,
wherein, upon receiving input of selecting the referring claim, one or more of color and shape of the arrow connected to the referred claim of the referring claim is changed.

17. A computer program stored in a record medium,
wherein, when combined with a computing apparatus, the computer program executes:
differentiating claims disclosed in a patent document into independent claims and dependent claims;
differentiating the independent claims and the dependent claims into referring claims and referred claims of the referring claims, and analyzing dependency relationships;
determining coordinates of the independent claims and the dependent claims according to claim numbers and the dependency relationships; and
displaying the claims sequenced according to the determined coordinates of the independent claims and the dependent claims.
